(19) United States
(12) Patent Application Publication
(10) Pub. No.: US 2013/0209288 A1
(43) Pub. Date: Aug. 15, 2013

(54) WIND TURBINE SYSTEM

(71) Applicant: Cheng-Te Wang, Changhua County (TW)

(72) Inventor: Cheng-Te Wang, Changhua County (TW)

(21) Appl. No.: 13/704,588

(22) PCT Filed: Jun. 17, 2011
(86) PCT No.: PCT/CN11/75842

§ 371 Date: Jan. 22, 2013

(30) Foreign Application Priority Data
Jun. 17, 2010 (CN) CN201020227408.X

(51) Int. Cl. F03D 9/00

(52) U.S. Cl. CPC F03D 9/00
USPC 417/334

(57) ABSTRACT

A wind turbine system that can comprise a wind power machine, a compressor, at least one energy accumulator, a dynamo, a pressurized heating system, and a depressurized cooling system; the wind power machine is driven by a wind power to transform wind energy into mechanical energy and to drive a compressor; the compressor pressurizes and stores gas in the energy accumulator; the energy accumulator stores and output the pressurized gas to drive the dynamo; the dynamo can comprise an air motor and an AC generator motor; wherein the air motor is driven by a gas outputted from the energy accumulator, and wherein the air motor drives the AC generator motor to generate electricity; the pressurized heating system can comprise a liquid/gas energy converter transforming hydraulic pressure into a gas pressure; the depressurized cooling system is connected between the energy accumulator and the dynamo.

### FIELD OF INVENTION

The present invention relates to a wind turbine system which has a pressurized heating effect and a depressurized cooling effect.

### BACKGROUND OF THE INVENTION

There are several types of conventional wind turbine system in today's wind power industry.

One type of conventional wind turbine system comprises an independent wind power generator used to transform wind energy into mechanical energy. A dynamo is driven by the mechanical energy to output direct current. The direct current is converted into stable voltage via rectifier so as to provide the stable voltage to a DC load or the direct current is transformed into alternative current through an inverter so as to provide the alternative current to an AC load.

The direct current is typically stored in a storage battery and transformed into the alternative current through the inverter providing electricity to the AC load. Since the output power is influenced by wind velocity and environmental factors, the storage battery set must have a very large capacity.

Another type of conventional turbine system is a mixed wind power generator which outputs alternative current by ways of a dynamo, transforms the alternative current into a stable voltage through a rectifier, and supply the stable voltage to a DC load. Likewise, the alternative current is stored in a storage battery set or is transformed into alternative current through an inverter, thus providing electricity to an AC load. The mixed wind power generator can also include an auxiliary power device for assisting the dynamo or generating solar energy. After the auxiliary power device generates the alternative current or the direct current, a shifter is shifted to provide the alternative current or the direct current to the AC load. The alternative current generated from the auxiliary power device can also be converted into the stable voltage through another rectifier and stored in the storage battery set.

A third conventional turbine system is a parallelly connected wind power generator. This turbine system includes a shifter for an automatic shift. In this system, when wind occurs, a dynamo outputs alternative current, and the alternative current is transformed into stable direct current via a rectifier. Thereafter, the direct current can be converted into alternative current by an inverter and supplied to an AC load. When there is no wind, electric will be supplied by mains electricity network.

Accordingly, the independent wind power generator or the mixed wind power generator stores electric energy by means of the storage battery set used as an auxiliary power so as to adjust instable power. The output efficiency of the wind power generator is typically around 20% to 40%, and is limited by the service life of the wind power generator.

Moreover, above-mentioned wind power generators provide electricity only as the wind velocity is over 3 to 4 m/s. If the wind velocity is over 20 m/s, the wind power generators can burn down. These wind power generators therefore operate at a limited wind velocity.

The present invention will mitigate and/or obviate the afore-described disadvantages.

### SUMMARY OF THE INVENTION

The primary object of the present invention is to provide a wind turbine system which has a pressurized heating effect and a depressurized cooling effect.

To obtain the above objectives, a wind turbine system provided by the present invention can comprise a wind power machine driven by a wind power so as to transform wind energy into mechanical energy and to drive a compressor; the compressor driven by the wind power machine and pressurizing and storing gas in at least one energy accumulator; the at least one energy accumulator served to store the gas in the compressor and to output the gas of the at least one energy accumulator so as to drive a dynamo; the dynamo including an air motor and an AC generator motor, and the air motor being driven by a gas which is outputted from the at least one energy accumulator, and the air motor driving the AC generator motor to generate electricity; a pressurized heating system including a liquid/gas energy converter disposed therein and transforming a hydraulic pressure into a gas pressure by mating with the compressor, and the gas pressure being stored in the at least one energy accumulator, such that a heat energy generates from an outlet of the pressurized heating system so as to supply the heat energy; a depressurized cooling system connected between the at least one energy accumulator and the dynamo so as to output and to depressurize the gas in the at least one energy accumulator, such that the dynamo is driven.

Thereby, the wind turbine system is applied for houses and comprises at least one set of wind power machine and compressor, and the at least one set of wind power machine and compressor is in connection with the liquid/gas energy converter of the pressurized heating system so as to store pressurized gas in the at least one energy accumulator, and a number of the at least one energy accumulator is increased or decreased based on use requirement. Also, the at least one energy accumulator couples with the dynamo so as to form a complete system loop, hence when wind occurs at a high or a low wind velocity, an wind energy drives the wind power machine to transform the wind energy into the mechanical energy, and then the compressor is driven by the mechanical energy. Thereafter, the liquid/gas energy converter converts the liquid energy into the gas pressure, and then the gas pressure is stored in the at least one energy accumulator. When desiring to use electricity, the gas pressure in the at least one energy accumulator is depressurized and outputted so as to drive the dynamo, thereafter the dynamo operates to supply the electricity to electric equipments, thus obtaining wind power. During transforming the hydraulic pressure into the gas pressure, a pressurized heating effect generates so as to supply the heat energy to water heater, electric furnace, indoor heating system, swimming pool, or sauna. When the gas pressure is depressurized and is outputted, a depressurized cooling effect generates for the air-conditioner or indoor air-conditioning system.

The foregoing, as well as additional objects, features and advantages of the invention will be more readily apparent from the following detailed description, which proceeds with reference to the accompanying drawings.

### THE BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a block diagram of an independent wind power generator.

FIG. 2 is a block diagram of a mixed wind power generator.

FIG. 3 is a block diagram of a parallelly connected wind power generator.

FIG. 4 is a block diagram of a wind turbine system according to a preferred embodiment of the present invention.

FIG. 5 is a perspective view showing the exploded components of the wind turbine system according to the preferred embodiment of the present invention.

FIG. 6 is a perspective view showing the assembly of the wind turbine system being installed in a building, according to the preferred embodiment of the present invention.

### DETAILED DESCRIPTION

In the following detailed description, reference is made to the accompanying drawings that form a part hereof, and in which is shown by way of illustration specific implementations that may be practiced. These implementations are described in sufficient detail to enable those skilled in the art to practice the implementations, and it is to be understood that other implementations may be utilized and that logical, mechanical, electrical and other changes may be made without departing from the scope of the implementation. The following detailed description is, therefore, not to be taken in a limiting sense.

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

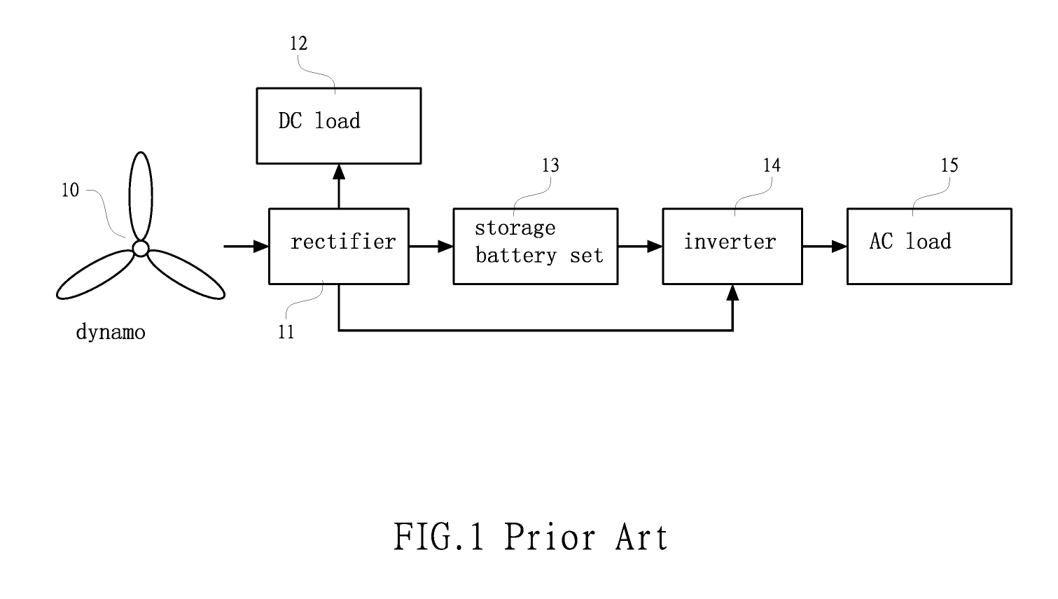

FIG. 1 shows a block diagram of an independent wind power generator. An independent wind power generator is used to transform wind energy into mechanical energy. A dynamo 10 is driven by the mechanical energy to output direct current, thereafter the direct current is converted into stable voltage via a rectifier 11 so as to provide the stable voltage to a DC load 12 or the direct current is transformed into alternative current through an inverter 14 so as to provide the alternative current to an AC load 15. The direct current is stored in a storage battery set 13 so when there is no wind, the direct current can be transformed into the alternative current through the inverter 14 providing electricity to the AC load 15.

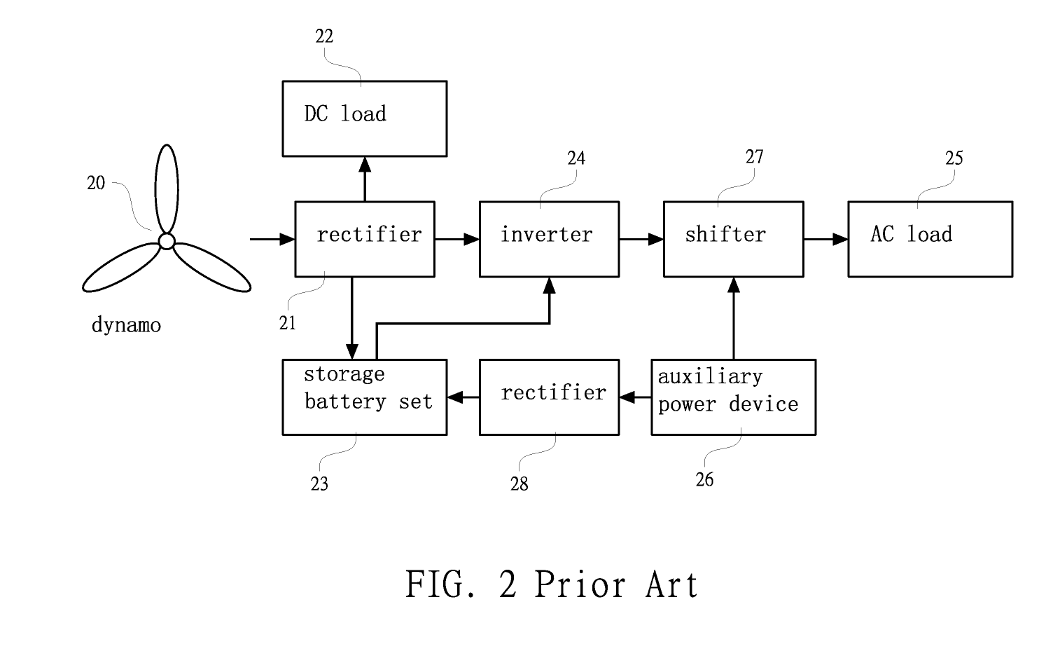

FIG. 2 shows a block diagram of a mixed wind power generator. A mixed wind power generator outputs alternative current by ways of a dynamo 20 and transforms the alternative current into a stable voltage through a rectifier 21 in order to supply the stable voltage to a DC load 22. The alternative current is stored in a storage battery set 23 or is transformed into alternative current through an inverter 24, thus providing electricity to an AC load 25. The mixed wind power generator can also include an auxiliary power device 26 for assisting the dynamo or generating solar energy. After the auxiliary power device 26 generates the alternative current or the direct current, a shifter 27 is shifted so as to provide the alternative current or the direct current to the AC load 25 or the alternative current generates from the auxiliary power device 26 and is converted into the stable voltage through another rectifier 28, thereafter the stable voltage is stored in the storage battery set 23.

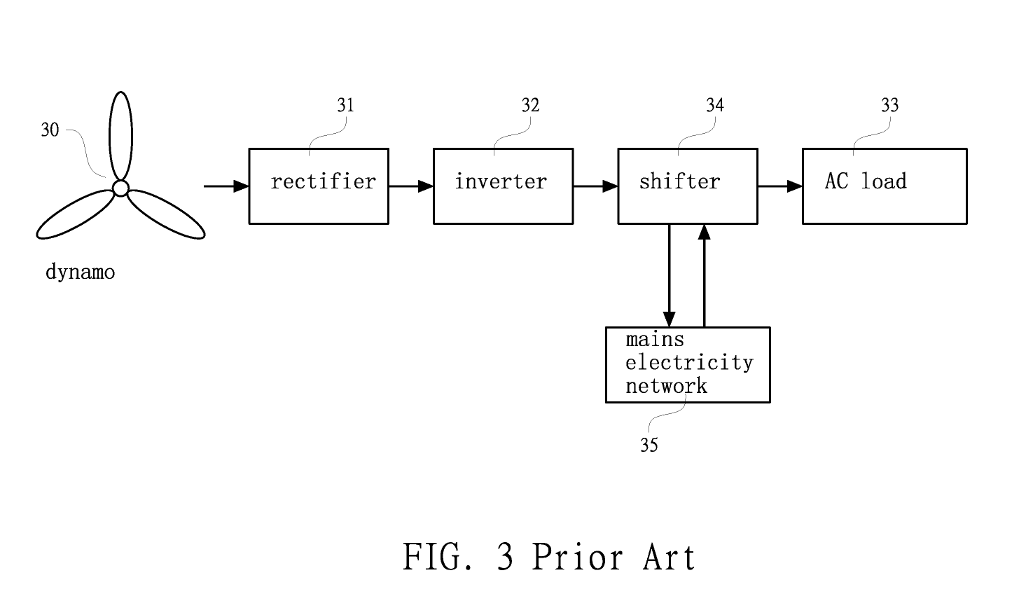

FIG. 3 is a block diagram of a parallelly connected wind power generator. A parallelly connected wind power generator includes a shifter 34 for an automatic shift. When there is wind, a dynamo 30 outputs alternative current, and then the alternative current is transformed into stable direct current via a rectifier 31. The direct current can be converted into alternative current by an inverter 32 and supplied to an AC load 33. When there is no wind, electricity can be supplied by mains electricity network 35.

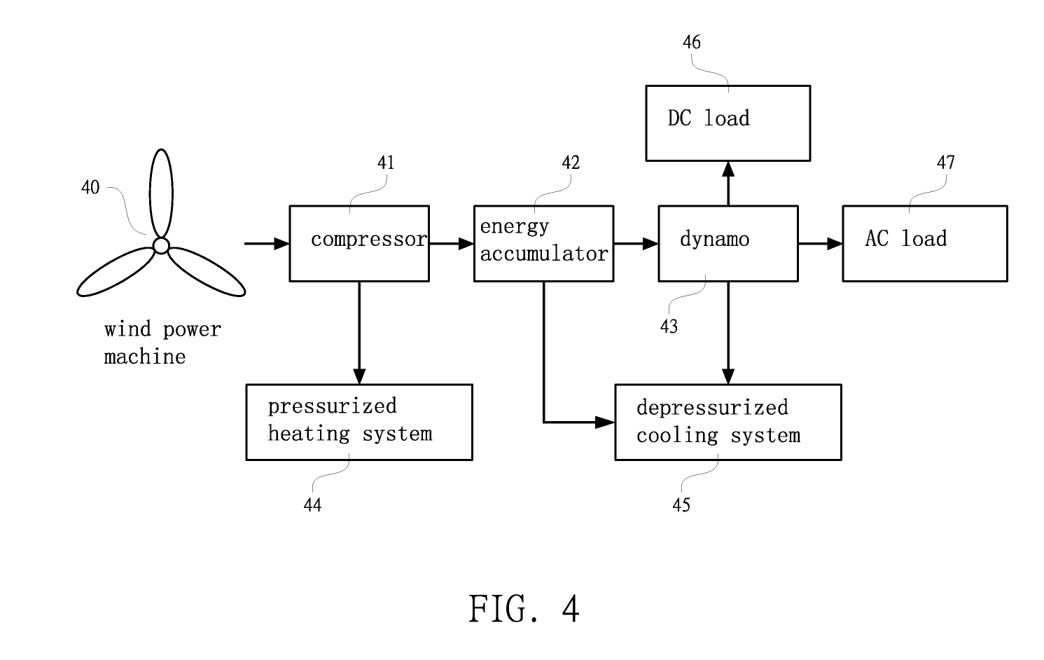

FIG. 4 is a block diagram of a wind turbine system according to a preferred embodiment of the present invention. A wind turbine system of the present invention comprises a wind power machine 40, a compressor 41, at least one energy accumulator 42, a dynamo 43, a pressurized heating system 44 connecting with the compressor 41, and a depressurized cooling system 45 coupling with the at least one energy accumulator 42, and the dynamo 43; the dynamo 43 being applied to supply electricity to the DC load 46 and AC load 47, wherein the wind power machine 40 is used to transform wind energy into mechanical energy and includes a plurality of horizontal or vertical vanes 401.

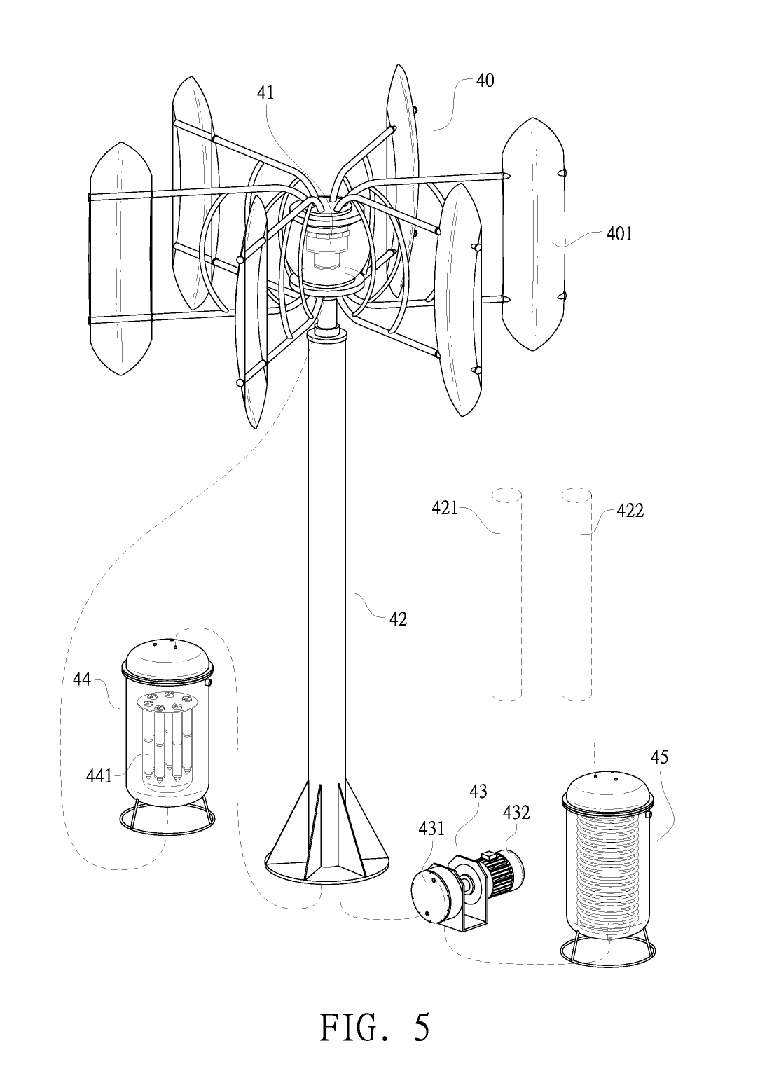

FIG. 5 is a perspective view showing the exploded components of the wind turbine system according to the preferred embodiment of the present invention. The wind power machine can comprise a plurality of vertical vanes 401, each having a rotary shaft (not numbered) for directly or indirectly driving the compressor 41 so as to pressurize and store gas in the at least one energy accumulator 42, and the wind power machine 40 is fixed at a certain height so as to achieve wind energy well.

The compressor 41 can comprise a liquid/gas energy transformer mounted therein is driven by the rotary shaft of the wind power machine 40 and adjusting compression efficiency automatically based on a wind velocity, i.e., the liquid/gas energy transformer of the compressor is driven by the wind power machine 40 to pressurize and then store the gas in the at least one energy accumulator 42 or in at least one high-pressure gas cylinder 421, 422 of the energy accumulator 42.

The energy accumulator 42 is set at a predetermined volume on the basis of use requirement and includes at least one high-pressure gas cylinder 421, 422, such that the energy accumulator 42 allows storing a certain amount of gas, and the wind power machine 40 is supported by the at least one energy accumulator 42; the energy accumulator 42 can be a column shape and have a height for matching with the wind power machine 40; the dynamo 43 can comprise an air motor 431 and an AC generator motor 432, and the air motor 431 is driven by a gas pressure which is outputted from the energy accumulator 42, and the air motor 431 drives the AC generator motor 432 to generate electricity that the energy accumulator 42 outputs the gas used as a power source, so an output of the electricity is stable, and alternating current of the electricity is supplied to the AC load 47 or is converted and supplied to the DC load 46.

The pressurized heating system 44 is a hot-water storage cylinder with a cold and heat exchange function and includes a liquid/gas energy converter 441 disposed therein and connecting with the compressor 41 to transform a hydraulic pressure into a gas pressure by connecting with the compressor 41, and the gas pressure is stored in the at least one energy accumulator 42, wherein a temperature of an outlet of the liquid/gas energy converter 441 is 80 to 180 Celsius, such that solar energy is replaced by a heat energy from the outlet of the liquid/gas energy converter 441 or is used in a water heater or indoor heating system.

The depressurized cooling system 45 is a cold-water storage cylinder with a cold and heat exchange function and is connected between the energy accumulator 42 and the dynamo 43 so that as the gas in the energy accumulator 42 is outputted and is depressurized to drive the dynamo 43, a temperature of an exit of the depressurized cooling system 45 is −40 to −60 Celsius, such that cold energy from the exit of the depressurized cooling system 45 is used in an air conditioner or indoor air-conditioning system.

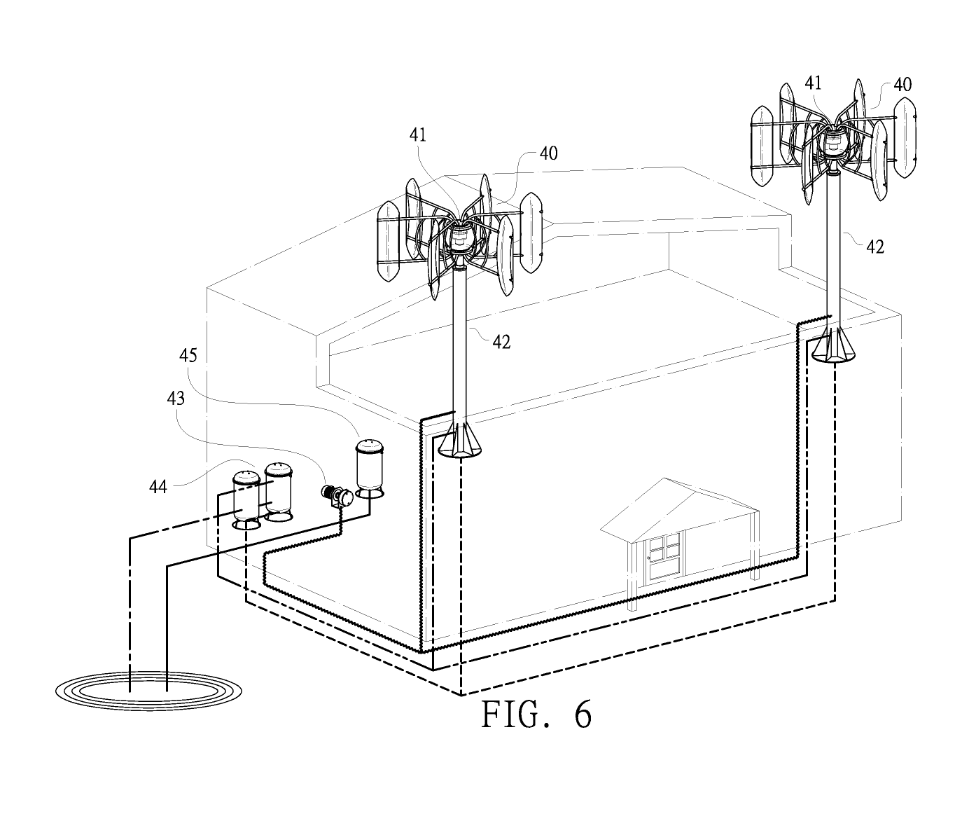

FIG. 6 is a perspective view showing the assembly of the wind turbine system being installed in a building, according to the preferred embodiment of the present invention. The wind turbine system is applied for houses and comprises at least one set of wind power machine 40 and compressor 41, and the set of wind power machine 40 and compressor 41 is in connection with the liquid/gas energy converter 441 of the pressurized heating system 44 so as to store pressurized gas in the at least one energy accumulator 42, and a number of the energy accumulator 42 can be increased or decreased based on use requirement.

Also, the accumulator 42 can couple with the dynamo 43 so as to form a complete system loop, hence when wind occurs at a high or a low wind velocity, an wind energy drives the wind power machine 40 to transform the wind energy into the mechanical energy, and then the compressor 41 is driven by the mechanical energy. Thereafter, the liquid/gas energy converter 441 converts the liquid energy into the gas pressure, and then the gas pressure is stored in the energy accumulator 42. When electricity is needed, the gas pressure in the at least one energy accumulator 42 is depressurized and outputted to drive the dynamo 43 causing the dynamo 43 to operate to supply the electricity. During transforming the hydraulic pressure into the gas pressure, a pressurized heating effect can be generated to supply the heat energy to water heater, electric furnace, indoor heating system, swimming pool, or sauna. When the gas pressure is depressurized and is outputted, a depressurized cooling effect can be generated for the air-conditioner or indoor air-conditioning system.

The wind turbine system of the present invention has the following advantages: 1) The wind turbine system is capable of storing energy or generating electricity even at a lowest wind velocity, 2) The wind turbine system operates without using storage battery, 3) The heating capacity of the wind turbine system is capable of replacing solar water heater, electric furnace or indoor heating systems, 4) The cooling capacity of the wind turbine system allows providing the cold energy to air conditioner or indoor air-conditioning system, 5) An energy storage capacity of the wind turbine system is enhanced, 6) The air motor is driven by the gas pressure which is outputted from the at least one energy accumulator, and the air motor drives the AC generator motor to generate electricity, such that the at least one energy accumulator outputs the gas used as the power source, so the output of the electricity is stable, 7) The power generation load is adjusted automatically with electricity consumption, thus preventing from a waste of stored energy, 8) The wind turbine system is capable of enhancing storage capacity easily without limiting electricity generating time, 9) The wind turbine system operates without using storage battery, so avoiding poor efficiency of the storage battery, 10) The wind turbine system is capable of storing energy or generating electricity even at the lowest wind velocity, thus erecting the wind turbine system at any site without being limited by wind velocity and direction.

What is claimed is:

1. A wind turbine system comprising:
a wind power machine, wherein the said wind power machine is driven by a wind power to transform wind energy into mechanical energy and to drive a compressor;
a compressor, wherein the said compressor is powered by the wind power machine pressurizes gas;
at least one energy accumulator, wherein the said accumulator is capable of storing the pressurized gas output by the compressor and wherein the energy accumulator can output the stored gas to drive a dynamo;
a dynamo, wherein the said dynamo can further comprise an air motor and an AC generator motor, and wherein the air motor is driven by a gas which is outputted from the said accumulator, and wherein the said air motor drives the AC generator motor to generate electricity;
a pressurized heating system, wherein the said pressurized heating system is connected to the compressor, wherein the said pressurized heating system can further comprise a liquid/gas energy converter, wherein the said energy converter can transform the hydraulic pressure into a gas pressure when connected with the compressor, and wherein the gas pressure can be used to generate heat energy; and
a depressurized cooling system, wherein the said depressurized cooling system is connected between the said energy accumulator and the said dynamo, wherein the said depressurized cooling system can depressurize and output the pressurized gas in the accumulators to drive the dynamo.

2. The wind turbine system as claimed in claim 1, wherein the wind power machine comprises a plurality of horizontal vanes or a plurality of vertical vanes, wherein each said horizontal vane and vertical vane further comprises a rotary shaft for directly or indirectly driving the compressor.

3. The wind turbine system as claimed in claim 1, wherein the said accumulator comprises at least one high-pressure gas cylinder.

4. The wind turbine system as claimed in claim 1, wherein the said accumulator is a column shape and can be used as support for the wind power machine.

5. The wind turbine system as claimed in claim 1, wherein the pressurized heating system further comprises a hot-water storage cylinder with a cold and heat exchange function and a liquid/gas energy converter.

6. The wind turbine system as claimed in claim 1, wherein the depressurized cooling system further comprises a cold-water storage cylinder with a cold and heat exchange function.

7. The wind turbine system as claimed in claim 1, wherein the compressor further comprises a liquid/gas energy transformer.

8. A wind turbine system comprising:
a wind power machine, wherein the said wind power machine is driven by a wind power to transform wind energy into mechanical energy and to drive a compressor;
a compressor, wherein the said compressor is powered by the wind power machine pressurizes gas;
at least one energy accumulator, wherein the said accumulator is capable of storing the pressurized gas output by the compressor and wherein the energy accumulator can output the stored gas to drive a dynamo; and
a dynamo, wherein the said dynamo can further comprise an air motor and an AC generator motor, and wherein the air motor is driven by a gas which is outputted from the said accumulator, and wherein the said air motor drives the AC generator motor to generate electricity.
